(19) United States
(12) Patent Application Publication
(10) Pub. No.: US 2025/0258271 A1
(43) Pub. Date: Aug. 14, 2025

(54) RADAR SYSTEM AND CONTROL METHOD THEREOF

(71) Applicant: CALTERAH SEMICONDUCTOR TECHNOLOGY (SHANGHAI) CO., LTD., Shanghai (CN)

(72) Inventors: Yi Chen, Shanghai (CN); Yan Zhu, Shanghai (CN); Jiashu Chen, Shanghai (CN); Leilei Huang, Shanghai (CN); Wenting Zhou, Shanghai (CN); Zhonglei Hao, Shanghai (CN); Kai Yang, Shanghai (CN); Pengfei Jiang, Shanghai (CN); Zhengdong Liu, Shanghai (CN)

(21) Appl. No.: 19/169,284

(22) Filed: Apr. 3, 2025

Related U.S. Application Data
(63) Continuation-in-part of application No. 17/297,406, filed on Dec. 27, 2021, now Pat. No. 12,282,085.

(30) Foreign Application Priority Data
Nov. 29, 2018 (CN) 201811445465.2

(51) Int. Cl. G01S 7/00; G01S 7/35; G01S 13/931

(52) U.S. Cl. CPC G01S 7/006; G01S 7/354; G01S 7/356; G01S 13/931

(57) ABSTRACT

A radar system and control method thereof is disclosed. The radar system comprises a plurality of radar units, each comprising: one or more radio frequency (RF) channels configured to receive a reflected signal and then generate an analog input signal according to the reflected signal; and a processing module connected with all the RF channels and configured to sample the analog input signal to obtain a digital signal and perform the first digital signal processing on the digital signal to obtain intermediate data, wherein when the plurality of radar units work jointly, a designated radar unit performs the second digital signal processing on the plurality of intermediate data provided by the plurality of radar units, thereby obtaining result data of the radar system.

### CROSS-REFERENCE TO RELATED APPLICATIONS

This application is a continuation-in-part of U.S. patent application Ser. No. 17/297,406, field Dec. 27, 2021, which is a national stage application under 35 U.S.C. § 371 of co-pending International Patent Application No. PCT/CN2019/091576, filed Jun. 17, 2019, which claims the priority of Chinese Patent Application No. 201811445465.2, filed Nov. 29, 2018, titled “Radar System and Control Method Therefor,” the entire contents of which are incorporated herein by reference.

### TECHNICAL FIELD

The present disclosure relates to the field of radio communication, and more specifically, to a radar system and processing method thereof.

### BACKGROUND

Existing radar systems generally include a processor and multiple radio frequency chips (or radio frequency modules) arranged in an array. In order to achieve synchronization of each radio frequency chip, the processor needs to provide a corresponding synchronization signal sync to each radio frequency chip. Each radio frequency chip obtains the received signal through the corresponding antenna, and converts the received signal into an intermediate frequency signal IF according to the synchronization signal sync. The processor performs signal processing on the intermediate frequency signal IF from each radio frequency chip, so as to parse and obtain the final data provided by the received signal.

### SUMMARY

The present disclosure provides a radar system and a radar system control method. By distributing at least part of signal processing in each radar unit, the radar system and the control method thereof reduce the difficulty of development and the cost of implementation, enjoy the advantage of good scalability, and make it easier to integrate more RF channels in the radar system so as to build a large-scale radar system, thereby improving the detection range and the accuracy and resolution of the detection angle.

According to one aspect of the present disclosure, there is provided a radar system comprising a plurality of radar units, each of which comprises one or more RF channels configured to receive a reflected signal and then generate an analog input signal according to the reflected signal and a processing module connected with the one or more RF channels and configured to sample the analog input signal to obtain a digital signal and perform the first digital signal processing on the digital signal to obtain intermediate data. In one embodiment, when the plurality of radar units work jointly, a designated radar unit performs the second digital signal processing on the plurality of intermediate data provided by the plurality of radar units, thereby obtaining result data of the radar system; within the radar unit, the processing module performs the second digital signal processing process on the intermediate data when the radar unit works alone, thereby obtaining the result data of the radar unit.

According to another aspect of the present disclosure, there is provided a control method for the radar system, the radar system comprising a plurality of radar units. The control method includes: (a) generating, by each of the plurality of radar units respectively, an analog input signal based on the received signal, and sampling, by each of the plurality of radar units respectively, the analog input signal to obtain a corresponding digital signal; (b) performing, by each of the plurality of radar units respectively, the first digital signal processing on the sampled digital signal, thereby obtaining corresponding intermediate data; and (c) performing, by the designated radar unit, when the plurality of radar units work jointly, the second digital signal processing on the plurality of intermediate data provided by the plurality of radar units, thereby obtaining result data of the radar system.

In the embodiments of the present disclosure, the radar system and the control method thereof replace the processor that processes data in a unified manner in the prior art, by distributing part or all of the signal processing among the radar units. Therefore, the requirement for the processing capability of each radar unit is relatively low, making the radar system have better scalability and reducing the implementation cost of the radar system. Accordingly, it is easy to increase the number of RF channels to build a large-scale radar system, which improves the detection range and the accuracy and resolution of the detection angle. Meanwhile, the structure of each radar unit is similar or identical, so the design time and the complexity of the system are greatly reduced when designing or extending the radar system. With no need to redesign different chips or modules separately, the radar system and the control method thereof boost the efficiency of design and reduce the cost and difficulty of design.

In an alternative embodiment, each radar unit may be implemented in group or independently through an SoC chip, thereby enhancing the on-chip integration of the radar system.

In some optional embodiments, the radar system and the control method thereof are of a simple structure, employing a transmission unit with a bus architecture to realize synchronization and data transmission among the radar units. In other embodiments, the radar system and the control method thereof employ a transmission unit with a master-slave structure, and divide signal processing into multiple parts, each of which can be performed in a single radar unit or executed separately in a plurality of radar units, thereby realizing the foregoing technical effects, as well as lowering the requirements for the processing capability of each radar unit. The radar system is more highly flexible with no need to configure a bus with strong data carrying capacity and transmission capability, further reducing the difficulty in extension and the cost of the radar system, thereby making it easier to improve the detection range and the accuracy and resolution of detection angle.

According to another aspect of the present disclosure, a radar system is further provided, including a plurality of cascaded radar units including a master radar unit and at least one slave radar unit, wherein the master radar unit is configured to provide local oscillator signals and sampling clock signals to the master radar unit and all of the at least one slave radar unit such that the local oscillator signals and the sampling clock signals of all of the radar units in the radar system are synchronized.

The radar system according to the embodiment of the present disclosure can realize synchronization of the local oscillator signals and the sampling clocks of all the radar units based on the signals provided by the master radar unit, and requires low processing capabilities of slave processing units, so that the radar system has better scalability and reduces costs of the radar system.

According to another aspect of the present disclosure, a radar system is further provided, which includes a plurality of radar units, each of the radar units including: at least one radio frequency channel, wherein each radio frequency channel is configured to obtain a received signal and generate an analog input signal from the received signal; a processing module connected to the at least one radio frequency channel; wherein the processing module is configured to sample the analog input signal to obtain a digital signal, and perform a first digital signal processing process on the digital signal to obtain intermediate data, wherein when the plurality of radar units work jointly, data exchange is performed among the plurality of radar units to equally divide all the intermediate data, and after the data exchange, all data units having a same index value in the intermediate data are concentrated into a radar unit corresponding to the index value; and the plurality of radar units perform second digital signal processing based on the intermediate data after the data exchange so that load balancing is achieved when the plurality of radar units perform the second digital signal processing.

In the radar system according to the embodiment of the present disclosure, when a plurality of radar units work jointly, the intermediate data obtained by the first digital signal processing process is exchanged among the radar units to equally divide all the intermediate data, so that the load balancing is achieved when the radar units perform the second digital signal processing. Since all data units having a same index value in the intermediate data are concentrated into a radar unit corresponding to the index value, the second digital signal processing and subsequent processing can be performed based on the received data of all the antennas. In the embodiment of the present disclosure, processing performance of the radar system is improved by the data exchange, data processing resources in the radar system can be utilized to the greatest extent by the load balancing, and requirement on processing capabilities of the radar units is low, so that the radar system has a better scalability and a reduced cost, and thus it is possible to easily increase the number of radio frequency channels to build a large-scale radar system.

### BRIEF DESCRIPTION OF THE DRAWINGS

By following description of embodiments with reference to the accompanying drawings of the present disclosure, the foregoing and other objects, features and advantages of the present disclosure will become apparent.

FIG. 1 shows a structural schematic diagram of a plurality of radar units in a radar system in an alternative embodiment of the present disclosure.

FIG. 2 shows a flowchart of data processing by a processing module in an alternative embodiment of the present disclosure to perform a data processing process.

FIG. 3 shows a schematic block diagram of a radar system according to an alternative embodiment of the present disclosure.

FIG. 4 shows a schematic block diagram of a radar system according to another alternative embodiment of the present disclosure.

FIG. 5 shows a partial schematic diagram of the synchronization mechanism of the radar system.

FIG. 6 shows a schematic block diagram of a first possible implementation structure of the radar system illustrated in FIG. 5.

FIG. 7 shows a schematic block diagram of a second implementation structure of the radar system illustrated in FIG. 5.

FIG. 8 shows a schematic block diagram of a third implementation structure of the radar system illustrated in FIG. 5.

FIG. 9 is a flowchart of a radar system control method in a fourth embodiment of the present disclosure.

FIG. 10A shows a schematic structural diagram of a radar system in which two radar units are cascaded according to an alternative embodiment of the present disclosure.

FIG. 10B shows a schematic structural diagram of a radar system in which three radar units are cascaded according to an alternative embodiment of the present disclosure.

FIG. 11 shows a schematic block diagram of a radar system for pre-processing and data exchange according to an alternative embodiment of the present disclosure.

FIG. 12 shows a schematic diagram of the radar system shown in FIG. 11 performing data exchange based on odd-numbered and even-numbered range gates.

### DETAILED DESCRIPTION

Various embodiments of the present disclosure will be described in more detail with reference to figures of the embodiments. In the figures, the same elements are referenced by same or similar identical reference markings. For clarity, elements in the figures are not drawn to scale. Additionally, some well-known parts may not be illustrated in the drawings.

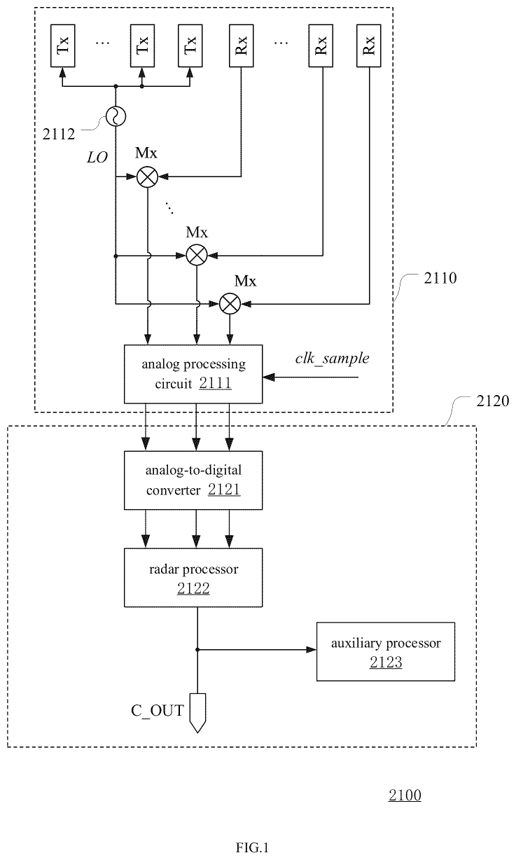

FIG. 1 shows a structural schematic diagram of a plurality of radar units in a radar system in an alternative embodiment of the present disclosure.

As shown in FIG. 1, the radar system of the first embodiment of the present disclosure includes a plurality of radar units 2100 that may be arranged to be an array.

Each radar unit 2100 includes a front-end module 2110, a processing module 2120, and one or more antennas configured to be a receiving antenna and/or a transmitting antenna for receiving signals and/or emitting signals.

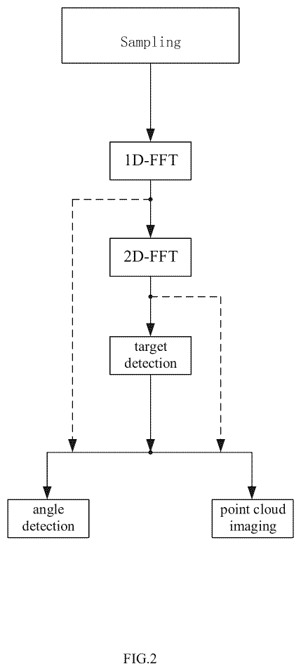

The front-end module 2110 converts the signal received via each antenna to a corresponding analog input signal according to a LO signal, so that the front-end module 2110 and the one or more antennas (which may form an antenna array) form one or more RF channels of the radar unit 2100. In one embodiment, the transmitting antenna may emit a signal based on the same LO signal. As shown in FIG. 2, the front-end module 2110 includes a plurality of antennas providing Tx channels, a plurality of antennas providing Rx channels, a plurality of mixers Mx, an analog processing circuit 2111, and a local oscillator signal generator 2112. In the process of receiving signals, each mixer Mx respectively mixes the signal received by a corresponding Rx channel with the LO signal to obtain a primary analog signal. Each primary analog signal is converted to an analog input signal in the analog processing circuit 2111. In some embodiments, the LO signal generated by the local oscillator signal generator 2112 is shared by all Tx channels and Rx channels.

Connected with each RF channel, the processing module 2120 is configured to obtain a digital signal by sampling the analog input signal and obtain intermediate data by performing the first digital signal processing on the digital signal. Specifically, the processing module 2120 includes an analog-to-digital converter 2121 and a radar processor 2122. The analog-to-digital converter 2121 is configured to obtain a corresponding digital signal by sampling the analog input signal according to a sampling clock (clk_sample) signal; The radar processor 2122 includes 1 to M sub-processing units and storage units for storing intermediate data and/or result data, where the 1st to Kth sub-processing units are used for implementing the first data processing, and the K+1th to Mth sub-processing units are used for implementing the second data processing, where M is a natural number greater than or equal to 2 and K is a natural number greater than or equal to 1 and less than M.

The radar unit 2100 provides intermediate data for external circuits (for example, any other radar unit or other external circuits) through a corresponding port C_OUT.

Optionally, all RF channels and the processing module 2120 in each radar unit are integrated into the same SoC chip.

In some embodiments, the processing module 2120 of each radar unit further includes an auxiliary processor 2123. The auxiliary processor 2123 may further process the output data provided by the radar processor 2122 and output the intermediate data then obtained through the corresponding port C_OUT.

In this embodiment, the signals received by each radar unit in the radar system will eventually be converted to result data of the radar system through the first and second digital signal processing. Each radar unit can work alone or jointly. When radar units work jointly, a designated radar unit performs the second digital signal processing on the intermediate data provided by all radar units to obtain result data of the radar system; When radar units work alone, each of the radar units working independently constitutes a radar system, where the processing module of the radar unit continues to perform the second digital signal processing on the intermediate data obtained, thereby obtaining the result data of the radar unit.

In embodiments of the present disclosure, a plurality of radar units in the radar system may jointly process the received data, thus obtaining result data, such as the range, velocity and angle information of the target, or the point cloud radar image based on the result data. This is further explained as an example below.

FIG. 2 is a flowchart of data processing by a processing module according to a first embodiment of the present disclosure. As shown in FIG. 2, in this embodiment, the result data includes, for example, the result data obtained after the angle detection and/or the result data obtained after the point cloud imaging. For example, the 1st to Mth sub-processing units in the radar processor 2122 respectively perform at least part of processes of Fourier transform, target detection, angle detection and point cloud imaging, where the Fourier transform may include the first-dimensional fast Fourier transform (1D-FFT) and the second-dimensional fast Fourier transform (2D-FFT).

As shown in FIG. 2, when the radar unit works alone, the analog-to-digital converter in the processing module first samples an analog input signal to obtain a digital signal, and then based on the digital signal, the radar processor carries out Fourier transform (1D-FFT and 2D-FFT), target detection, etc., thereby obtaining final result. In this case, the radar unit operates as a radar system alone, the relevant flow of which is illustrated by the solid arrows in FIG. 2.

When the radar unit jointly works with other radar units or circuits, as shown by the dotted lines in FIG. 2, the radar processor may transmit the results of the 1D-FFT, 2D-FFT and target detection, functioned as intermediate data, to any other radar unit or other circuits based on the digital signal obtained after the analog-to-digital converter of the radar unit samples an analog input signal, thereby in principle realizing data exchange between the radar unit and external circuits at any data processing stage. The radar unit or other circuits receiving the intermediate data continues to transmit intermediate data to other circuits or to perform the second data processing on the intermediate data (for example, angle detection and point cloud imaging shown in FIG. 2). In this case, the radar unit realizes a distributed radar processing system with any other radar unit and/or other circuits.

In an alternative embodiment, the radar system disclosed in the present disclosure can also transmit the data to the radar units for further processing after part of the sub-steps are executed in one designated radar unit, and then obtain result data by processing the data provided by the radar units in one designated radar unit again. That is, the data processing processes for the radar system may include at least one centralized data processing (executed in a designated radar unit) and at least one distributed data processing (executed separately in each radar unit).

In one preferred embodiment, the amount of data calculated in each centralized processing is smaller than that in the distributed processing, thus avoiding being burdensome on the data transmission capability of each radar unit and the data carrying capacity of the designated radar unit for centralized processing.

The data processing process in FIG. 2 will be illustrated as an example. Because the data throughput before target detection and the required storage space are huge, it is hard to meet the real-time requirements for the radar system. In one preferred embodiment, each radar unit provides intermediate data after completing the data processing of target detection, ensuring that the amount of intermediate data provided by each radar unit and the required storage space are limited to a relatively small range, and therefore, the performance of the radar system is guaranteed. Further, what needs to be exchanged among the radar units are only the target addresses obtained after target detection and the corresponding 2D-FFT information; Subsequently, a designated radar unit performs the further data processing, such as angle detection, on the aggregated target addresses and the corresponding 2D-FFT information provided by all radar units, thereby obtaining result data in the designated radar unit.

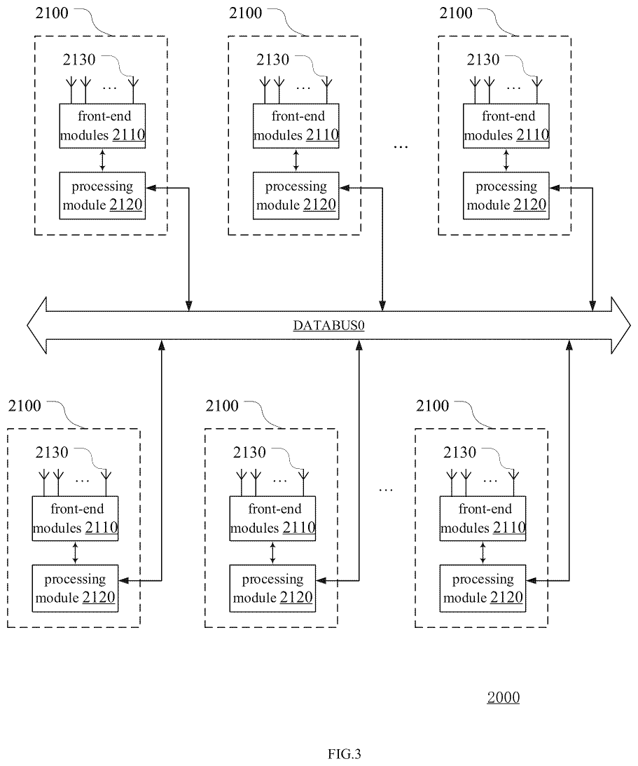

FIG. 3 is a schematic block diagram of a radar system according to a second embodiment of the present disclosure.

In the second embodiment of the present disclosure, as shown in FIG. 3, the radar system 2000 employs a bus structure DATABUS0 to realize synchronization and data transmission and exchange among the radar units 2100. The internal structure of each radar unit 2100 is the same as that of the radar unit shown in FIG. 1, details of which will not be described herein.

Optionally, the bus structure arranged on the circuit board where the radar system is located is distributed in multiple SoC chips, and the radar units are integrated into the corresponding SoC chips in group or independently. In one preferred embodiment, the multiple SoC chips may be distributed on both sides of the bus structure. In an alternative embodiment, the bus structure may also be directly arranged in the chip encapsulation structure.

In the foregoing embodiment, the radar system replaces the processor that processes data in a unified manner in the prior art with the processing module separately arranged in each radar unit. And the radar system employs a bus structure connected with all radar units to realize clock synchronization, data synchronization and data exchange. Therefore, the requirement for the processing capability of the processing module is relatively low, making the radar system have better scalability and reducing the implementation cost of the radar system. Accordingly, it is easy to increase the number of radio frequency channels to build a large-scale radar system, which improves the detection range and the accuracy and resolution of the detection angle; Meanwhile, the structure of radar units are similar or identical, so the design time and the complexity of the system are greatly reduced when designing or extending the radar system. With no need to redesign different chips or modules separately, the radar system and the control method thereof boost the efficiency of design and reduce the cost and difficulty of design.

The radar system of the foregoing embodiment employs a bus structure. However, with the RF channels increasing, the bus structure needs higher data carrying capacity and data transmission rate to support data sharing among the radar units. Meanwhile, a very strict synchronization mechanism is also needed among the radar units. For this reason, the present disclosure provides a radar system in the second embodiment on the basis of the radar system shown in FIG. 1, in order to reduce difficulty in designing transmission unit and synchronization mechanism.

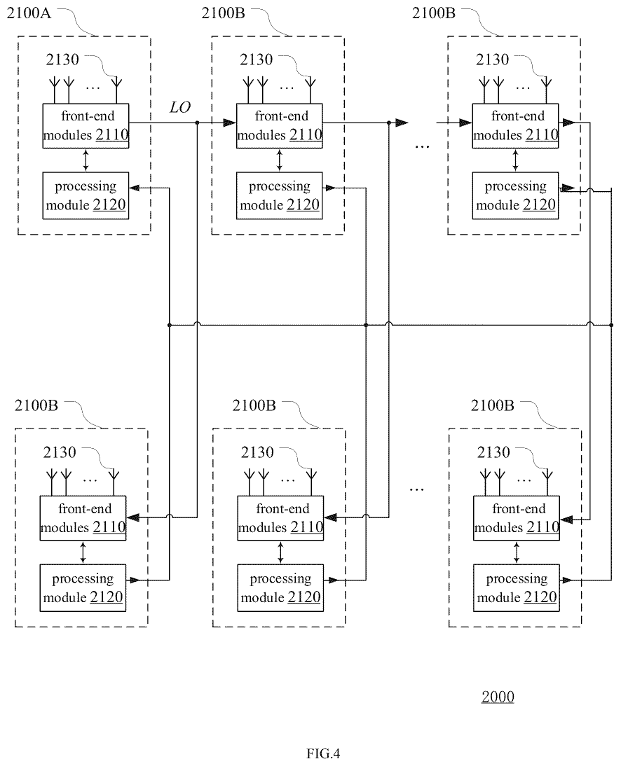

FIG. 4 is a schematic block diagram of a radar system according to a third embodiment of the present disclosure.

In the third embodiment of the present disclosure, as shown in FIG. 4, the radar system also includes a plurality of radar units. The internal structure of each radar unit is the same as that of the radar unit shown in FIG. 1, details of which will not be described herein.

Different from the radar system in the second embodiment, in the third embodiment, a plurality of radar units include a master radar unit 2100A and a plurality of slave radar units 2100B, thus forming a master-slave structure which differs from a bus structure. In this embodiment, the intermediate data generated by the processing module of each radar unit will be further performed the second digital processing in a designated radar unit (the master radar unit or one of the plurality of the slave radar units), so that final result data can be obtained by the designated radar unit.

Specifically, the master radar unit 2100A can be cascaded with the slave radar units 2100B in sequence, details of which will be described as an example below.

When a plurality of radar units work jointly, a synchronization mechanism is needed in order to synchronize the master radar unit 2100A and the slave radar units 2100B. The synchronization system mainly includes synchronization in three aspects. Specifically, the LO signals, the clk_sample signals of the analog-to-digital converter and all the processors inside the radar units should be synchronized. In one embodiment, the master radar unit 2100A generates and provides LO signals and clk_sample signals for all the slave radar units 2100B. Based on the same clk sample signal, the processing module of each radar unit samples a corresponding analog input signal. Each front-end module in the front-end transceiver link shares the same LO signal (For example, the main LO signal is provided directly or indirectly by the Phase Locking Loop (PLL) structure in the master radar unit 2100A for the front-end modules 2110 of the slave radar units 2100B.), thereby synchronizing all radar units.

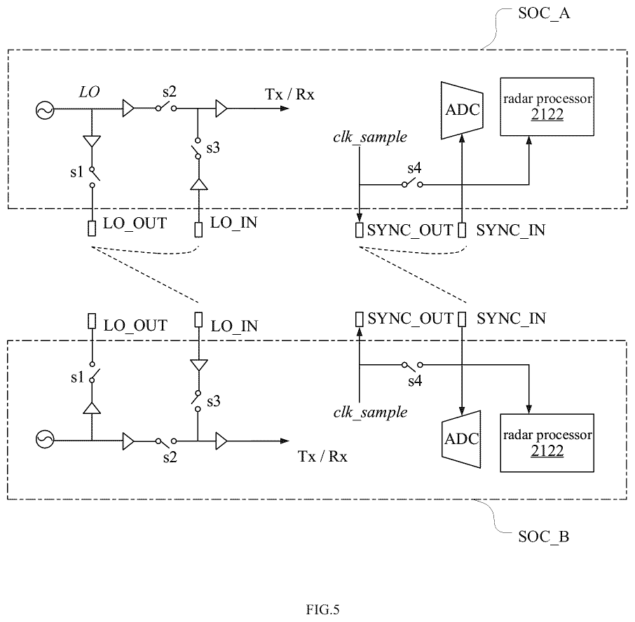

Based on FIG. 5, the synchronization mechanism of the radar system is described in detail below. It should be noted that only part of each radar unit (for example, a LO signal generator, a plurality of buffers or inverters, a plurality of switches, Tx channels, Rx channels, an analog-to-digital converter (ADC), and a radar processor, etc.) is shown in FIG. 5. In order to simplify the description, a radar system comprising two radar units is described as an example to illustrate the synchronization and data exchange among the radar units, but is not intended to limit the present invention. Persons skilled in the art may extend the radar system in the following embodiment to a radar system comprising more than two radar units as required.

As shown in FIG. 5, the master radar unit 2100A (for example, implemented by the first chip SoC_A) and the slave radar unit 2100B (for example, implemented by the second chip SoC_B) respectively have ports of LO signals, namely LO_OUT and LO_IN, and ports of clk_sample signals, namely SYNC_OUT and SYNC_IN.

When the radar unit works alone (For example, only the master radar unit operates in the radar system.), as shown in FIG. 5, in the master radar unit 2100A the switches s2 and s4 are closed, s1 and s3 are open, and meanwhile the ports of LO_OUT, LO_IN, SYNC_IN and SYNC_OUT (or the corresponding internal signals) are all disconnected (invalid); the slave radar unit 2100B is off.

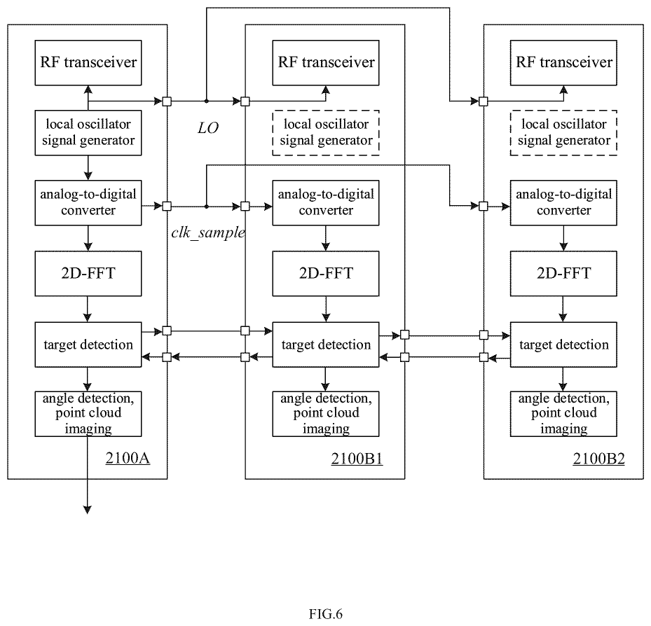

When the master radar unit and the slave radar units work jointly, in the master radar unit 2100A the switch s2 and s4 are open and s1 and s3 are closed. The switches of s1′, s2′, s4′ are open and the switch s3′ is closed in the slave radar unit 2100B; Meanwhile, the port LO_OUT of the master radar unit 2100A provides a LO signal for the port LO_IN of the master radar unit 2100A and the port LO_IN of the slave radar units 2100B. And the port SYNC_OUT of the master radar unit 2100A provides a clk_sample signal for the port SYNC_IN of the master radar unit and the port SYNC_IN of the slave radar units 2100B. Therefore, the LO signal synchronization and the clk_sample signal synchronization can be realized among the radar units. When the master radar unit and the slave radar units work jointly, the connection relationship between them is shown by the dotted line in FIG. 6.

FIG. 6 is a schematic block diagram of a first possible implementation structure of the radar system illustrated in FIG. 5. The radar system only shows three cascaded radar units in the figure, but is not intended to limit the embodiments of the present disclosure. Persons skilled in the art may accordingly design a radar system comprising two or more radar units. Meanwhile, it should be noted that some modules in the radar unit are not shown.

As shown in FIG. 6, the master radar unit 2100A transmits the target addresses obtained after its own target detection to the slave radar unit 2100B1. The first stage combined target addresses are generated from the target addresses obtained by the slave radar unit 2100B1 after its own target detection and the target address provided by the master radar unit 2100A (The first stage combined target addresses may include the target addresses provided by the master radar unit and/or the slave radar unit.), which is transmitted to the slave radar unit 2100B2; Likewise, the second stage combined target addresses are generated from the target addresses obtained by the slave radar unit 2100B2 after its own target detection and the first stage combined target addresses provided by the slave radar unit 2100B1 (The second stage combined target addresses may include the target addresses provided by the slave radar unit 2100B2 and/or the first stage combined target addresses provided by the slave radar unit 2100B1.), thereby generating final target addresses.

Subsequently, the final target addresses and the corresponding 2D-FFT information are transmitted back from the slave radar unit 2100B2 to the slave radar unit 2100B1; According to the final target addresses, the slave radar unit 2100B1 transmits back the corresponding 2D-FFT information and the 2D-FFT information provided by the slave radar unit 2100B2 to the master radar unit 2100A; The master radar unit 2100A provides for the radar processor in the master radar unit the corresponding 2D-FFT information according to the final target addresses and the 2D-FFT information transmitted from the slave radar units 2100B1 and 2100B2, which enables the angle detection unit or the point cloud imaging processing unit in the radar processor to further process the 2D-FFT information provided by each radar unit and generate result data of the radar system.

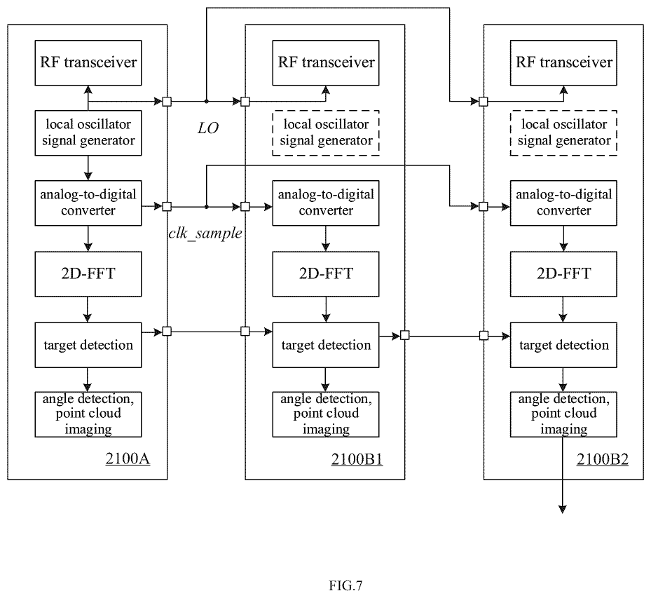

FIG. 7 is a schematic block diagram of a second implementation structure of the radar system illustrated in FIG. 5. Similarly, the radar system only shows three cascaded radar units in the figure, but is not intended to limit the embodiments of the present disclosure. Persons skilled in the art may accordingly design a radar system comprising two or more radar units. Meanwhile, it should be noted that some modules in each radar unit are not shown.

As shown in FIG. 7, the master radar unit 2100A transmits the target addresses obtained after its own target detection and the corresponding 2D-FFT information to the slave radar unit 2100B1. The slave radar unit 2100B1 obtains the target addresses after its own target detection and the corresponding information, and then generate the first stage combined target addresses according to the target addresses obtained by itself and the target addresses of the master radar unit 2100A (The first stage combined target addresses may include the target addresses provided by the master radar unit and/or the slave radar unit.). Then, the first stage combined target addresses and the corresponding 2D-FFT information respectively provided by the master radar unit 2100A and the slave radar unit 2100B1 are transmitted to the slave radar unit 2100B2; Likewise, the slave radar unit 2100B2 obtains the target addresses and the corresponding information after its own target detection, and then generate the second stage combined target addresses according to the target addresses obtained by itself and the first combined target addresses provided by the slave radar unit 2100B1 (The second stage combined target addresses may include the target addresses provided by the slave radar unit 2100B2 and/or the first stage combined target addresses provided by the slave radar unit 2100B1.). Subsequently, the slave radar unit 2100B2 obtains final target addresses according to the second stage combined target addresses. And according to the final target addresses, the slave radar unit 2100B2 transmits back the 2D-FFT information provided by the slave radar units 2100B1, 2100B2 and the master radar unit 2100A to the radar processor in the slave radar unit 2100B2, which enables the angle detection unit or the point cloud imaging processing unit in the radar processor to further process the 2D-FFT information provided by each radar unit and then generate result data of the radar system.

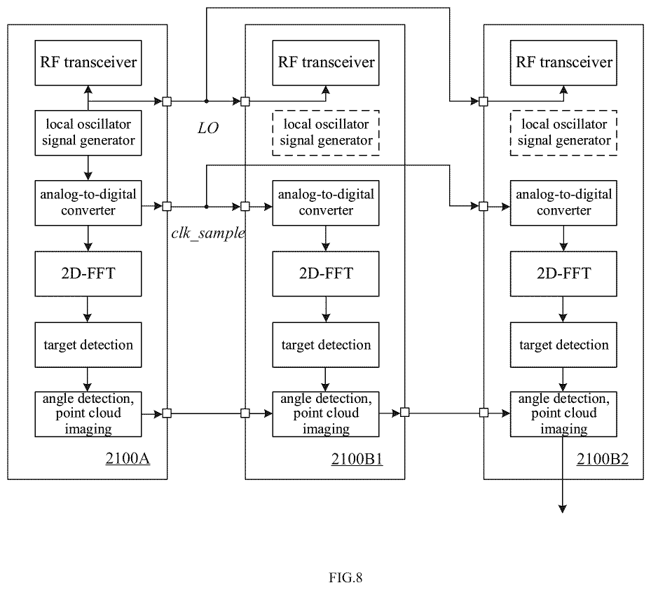

FIG. 8 is a schematic block diagram of a third implementation structure of the radar system illustrated in FIG. 5. Similarly, the radar system only shows three cascaded radar units in the figure, but is not intended to limit the embodiments of the present disclosure. Persons skilled in the art may accordingly design a radar system comprising two or more radar units. Meanwhile, it should be noted that some modules in each radar unit are not shown.

As shown in FIG. 8, the master radar unit 2100A transmits the target addresses obtained after its own target detection and the corresponding 2D-FFT information to the angle detection unit and the point cloud imaging processing unit in the radar processor. The processing units transmit the results of angle detection and the target addresses of the master radar unit to the slave radar unit 2100B1; The slave radar unit B1 generates the first stage combined target addresses according to the target addresses obtained after its own target detection and provided by the master radar unit (The first stage combined target addresses may include the target addresses provided by the master radar unit and/or the slave radar unit.). And the 2D-FFT information corresponding to the first stage combined target addresses is provided for the angle detection and point cloud imaging processing units in the slave radar unit 2100B1. The processing units correspondingly obtain the 2D-FFT information based on the first combined target addresses, and carries out calculations according to the 2D-FFT information and results of the angle detection provided by the master radar unit, thereby obtaining the first stage combined results. Finally, the first stage combined results and the first combined target addresses are collectively transmitted to the slave radar unit 2100B2; The slave radar unit 2100B2 generates the second stage combined target addresses based on the target addresses obtained after its own target detection and the first stage combined target addresses (The second stage combined target addresses may include the target addresses provided by the slave radar unit 2100B2 and/or the first stage combined target addresses provided by the slave radar unit 2100B1.). And the 2D-FFT information corresponding to the second combined target addresses is provided for the angle detection and point cloud imaging processing units in the slave radar unit 2100B2. The processing unit obtains corresponding 2D-FFT information according to the second stage combined target addresses, and carries out calculations according to the 2D-FFT information and the first stage combined results provided by the slave radar unit 2100B1, thus generating result data of the radar system.

The data processing in the FIG. 8 is described in detail below.

The angle detection and point cloud imaging are mainly used for calculating the energy distribution spectrum generated by the object at different angles. The peak point of the spectrum corresponds to the direction of the object and the direct output of the spectrum can be used to form point cloud image. Specifically, each reflector has a peak value in the 2D-FFT information of each Rx channel. It is assumed that there are n channels, and in this case, these peaks are respectively recorded as xi, i=1 . . . n. In order to obtain the energy distribution spectrum in different directions, it is necessary to generate the weighting coefficients_ωi(θ), i=1 . . . n according to the information contained in the digital signal converted from the received signal, where θ represents the direction angle, and for example, the range of values may be −90° to 90° and the interval of values may be 1°. The calculation formula for obtaining the energy distribution spectrum SpectrumBFM (θ) can be written as follows:

$${Spectrum}_{BFM} ( θ ) = {‖ {\sum }_{i = 1}^{n} {x}_{i} {ω}_{i} ( θ ) ‖}^{2} \qquad ( 1 )$$

Since n Rx channels are distributed in different radar units when all the radar units work jointly, each radar unit can only partially provide the peak xi of the part of n peaks. In some embodiments, each radar unit can only obtain partial weighting coefficients ωi(θ) of n weighting coefficients, that is, each radar unit can only obtain partial antenna information.

A radar system containing two radar units is illustrated as an example herein. It is assumed that the first radar unit contains n1 Rx channels and the second radar unit contains n2 Rx channels, where n1 and n2 are non-zero natural numbers and the sum of n1 and n2 is n. In this case, the calculation formula of the energy distribution spectrum SpectrumBFM (θ) can be written as follows:

$${Spectrum}_{B F M} ( θ ) = {‖ {\sum }_{i = 1}^{n 1} {x}_{i} {ω}_{i} ( θ ) + {\sum }_{i = n 1 + 1}^{n 2} {x}_{i} {ω}_{i} ( θ ) ‖}^{2} \qquad ( 2 )$$

As shown in FIG. 8, the first radar unit in a cascading radar system can directly transmit the calculated value of Σᵢ₌₁ⁿ¹ xᵢωᵢ(θ) to the second radar unit; And after the second radar unit obtains the value of Σᵢ₌ₙ₁₊₁ⁿ² xᵢωᵢ(θ), what it needs to do is to combine the two values, obtain a modulus and transmit the modulus to the next radar unit. By analogy, the result data, i.e. SpectrumBFM (θ), is finally obtained in the last radar unit.

In the radar system shown in FIG. 6 and FIG. 7, the maximum data transmission amount among radar units is proportional to the total number of radar units in the radar system. In the radar system shown in FIG. 8, the data transmission amount among radar units remains basically unchanged, and therefore, the scheme can further reduce the information transmission amount among radar units and enhance scalability.

In the third embodiment of the present disclosure, the radar system employs a transmission unit with a master-slave structure, and divides the signal processing into multiple parts, a corresponding part of which can be executed in a distributed manner in each radar unit or executed in a centralized manner in a designated radar unit, thereby realizing the foregoing technical effects, as well as lowering the requirements for the processing capability of each radar unit. The radar system is more highly flexible with no need to configure a bus with strong data carrying capacity and transmission capability, further reducing the difficulty in the extension and the cost of the radar system, thereby making it easier to improve the detection range and the accuracy and resolution of detection angle.

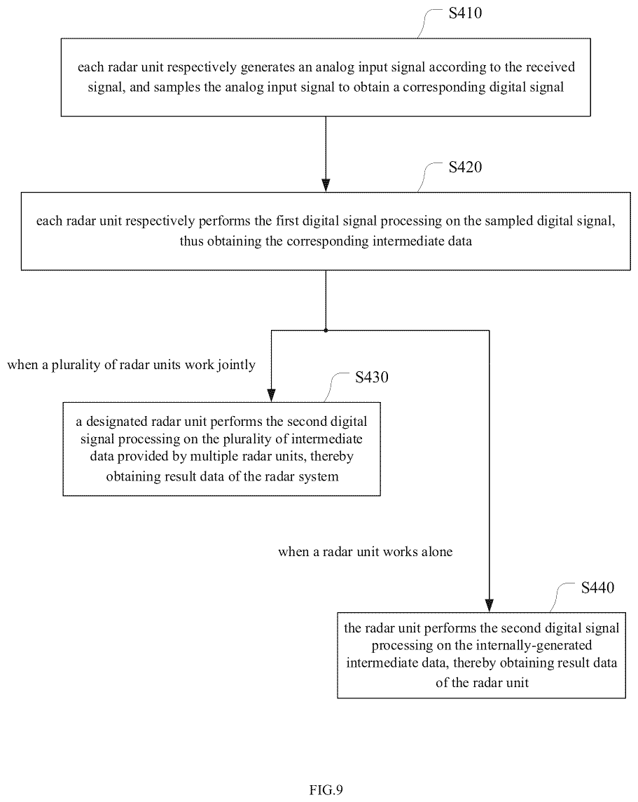

FIG. 9 is a flowchart of a radar system control method in a fourth embodiment of the present disclosure.

In the fourth embodiment of the present disclosure, the control method of the radar system includes steps from S410 to S440, where the radar system comprises a plurality of radar units (For example, the radar system is the system described in the foregoing embodiment).

In step S410, each radar unit respectively generates an analog input signal according to the received signal, and samples the analog input signal to obtain a corresponding digital signal. Specifically, each radar unit converts the received signal into the analog input signal according to a LO signal, and samples the analog input signal according to a clk_sample signal, so as to obtain a corresponding digital signal. In some embodiments, each radar unit emits a signal according to the same LO signal.

In step S420, each radar unit respectively performs the first digital signal processing on the sampled digital signal, thus obtaining the corresponding intermediate data.

In step S430, when a plurality of radar units work jointly, a designated radar unit performs the second digital signal processing on the plurality of intermediate data provided by multiple radar units, thereby obtaining result data of the radar system.

In step S440, when a radar unit works alone, the radar unit performs the second digital signal processing on the internally-generated intermediate data, thereby obtaining result data of the radar unit.

In an embodiment, each radar unit includes 1 to M sub-processing units, in which the 1st to Kth sub-processing units are used for implementing the first data processing, and the K+1th to Mth sub-processing units are used for implementing the second data processing, where M is a natural number greater than or equal to 2 and K is a natural number greater than or equal to 1 and less than M.

The 1st to Mth sub-processing units respectively perform at least part of processes of Fourier transform, target detection, angle detection and point cloud imaging. The first data processing, for example, includes 1D-FFT, 2D-FFT and target detection; The second data processing, for example, includes angle detection and point cloud imaging.

The connection relationship among radar units may be a master-slave structure or a bus structure. The corresponding control method may be referred to the foregoing embodiments, details of which will not be described herein.

In the embodiments of the present disclosure, the radar system and the control method thereof replace the processor that processes data in a unified manner in the prior art, by distributing part or all of the signal processing among the radar units. Therefore, the requirement for the processing capability of each radar unit is relatively low, making the radar system have better scalability and reducing the implementation cost of the radar system. Accordingly, it is easy to increase the number of RF channels to build a large-scale radar system, which improves the detection range and the accuracy and resolution of the detection angle. Meanwhile, the structure of each radar unit is similar or identical, so the design time and the complexity of the system are greatly reduced when designing or extending the radar system. With no need to redesign different chips or modules separately, the radar system and the control method thereof boost the efficiency of design and reduce the cost and difficulty of design.

In one embodiment, each radar unit may be implemented in group or independently through an SoC chip, thereby enhancing the on-chip integration of the radar system.

In some preferred embodiments, the radar system and the control method thereof are of a simple structure, employing a transmission unit with a bus architecture to realize synchronization and data transmission among the radar units. In other embodiments, the radar system and the control method thereof employ a transmission unit with a master-slave structure, and divide the signal processing into multiple parts, each of which can be performed in a single radar unit or executed separately in a plurality of radar units, thereby realizing the foregoing technical effects, as well as lowering the requirements for the processing capability of each radar unit. The radar system is more highly flexible with no need to configure a bus with strong data carrying capacity and transmission capability, further reducing the difficulty in the extension and the cost of the radar system, thereby making it easier to improve the detection range and the accuracy and resolution of detection angle.

An embodiment of the present disclosure further provides a radar system including a plurality of cascaded radar units, wherein the plurality of radar units includes a master radar unit and at least one slave radar unit, and the master radar unit is configured to provide local oscillator signals and sampling clock signals to the master radar unit and all of the at least one slave radar unit so that the local oscillator signals and sampling clock signals of all the radar units in the radar system are synchronized.

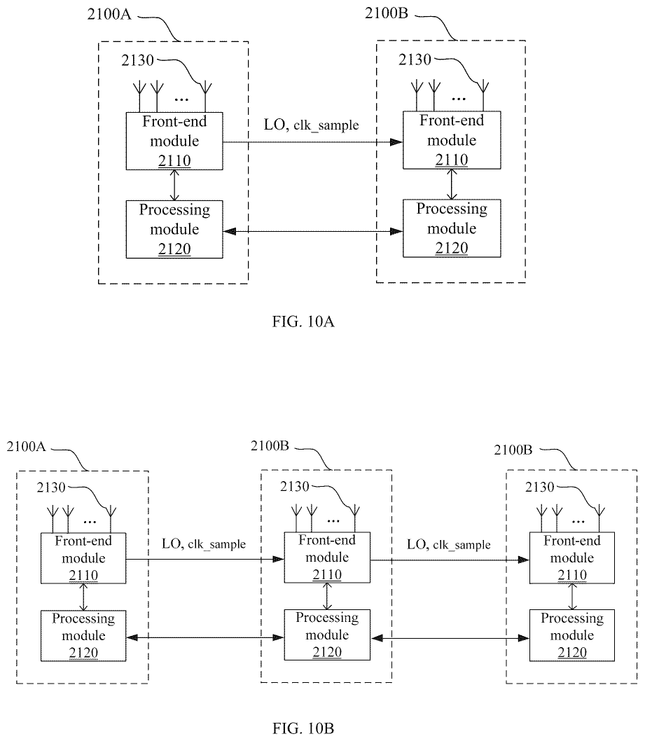

As illustrated in FIG. 10A as an example of the present embodiment, the radar system includes one master radar unit 2100A and one slave radar unit 2100B, and each radar unit may include an antenna 2130, a front-end module 2110, and a processing module 2120. The local oscillator signal LO and the sampling clock signal clk_sample of the master radar unit 2100A are transmitted to the slave radar unit 2100 B through a cascade interface in addition to being used by the master radar unit, so as to achieve synchronization of the local oscillator signals and the sampling clock signals of the master radar unit and the slave radar unit.

It should be noted that each radar unit of the present embodiment may be a chip such as an System on Chip (SoC) chip, an Antenna in Package (AiP) SoC chip including an antenna, a radar subsystem composed of an MMIC (Monolithic Microwave Integrated Circuit) chip and a processing (such as an MCU or a DSP) chip, or an MMIC chip having partial digital signal processing capabilities (such as at least partial processing capabilities such as ADC, 1D-FFT, and 2D-FFT). That is, 2130 in FIGS. 10A and 10B may be represented as a transceiver antenna provided in a package or a chip, or may be represented as a radio frequency channel connected to an external transceiver antenna, which may be specifically set according to actual requirements. For example, when it is an AiP chip, it may be considered that each radar unit includes a transceiver antenna, and the same radar unit may also be a SoC and/or MMIC chip including a radio frequency channel, which can be connected to external antennas (such as PCB antennas, Radiator on Package (RoP) waveguide antennas, etc.) to transmit and receive electromagnetic wave signals.

In an exemplary embodiment of the present disclosure, the radar unit includes: at least one radio frequency channel, wherein each radio frequency channel is configured to obtain a received signal and generate an analog input signal from the received signal; a processing module connected to the at least one radio frequency channel; wherein the processing module is configured to sample the analog input signal to obtain a digital signal, and perform a first digital signal processing process on the digital signal to obtain intermediate data; wherein in the radar unit, the processing module performs the second digital signal processing process on the intermediate data when the radar unit works alone, thereby obtaining the result data of the radar unit; when the plurality of radar units work jointly, a designated radar unit performs a second digital signal processing process on a plurality of the intermediate data sets provided by the plurality of radar units, thereby obtaining result data of the radar system; or when the plurality of radar units work jointly, data exchange is performed among the plurality of radar units to equally divide all intermediate data, and all data units having a same index value in the intermediate data after the data exchange are concentrated into a radar unit corresponding to the index value; and the plurality of radar units perform the second digital signal processing based on the intermediate data after the data exchange so that load balancing is achieved when the plurality of radar units perform the second digital signal processing.

In an exemplary embodiment of the present disclosure, the radar system is configured to perform data processing on an echo signal to obtain result data, and the data processing process includes a previous distributed processing process and a subsequent centralized processing process; wherein the distributed processing procedure is separately executed in each radar unit, and the centralized processing process is executed in the master radar unit; and when the radar units perform the previous distributed processing process, each radar unit respectively perform the processing process only based on the received echo signals.

In an exemplary embodiment of the present disclosure, the data processing process further includes at least one subsequent distributed processing process, or the data processing process further includes at least one subsequent distributed processing process and at least one subsequent centralized processing process; wherein the distributed processing process and the centralized processing process are executed alternately, and the number of times of the distributed processing processes is equal to the number of times of the centralized processing processes, or the number of times of the distributed processing processes is equal to the number of times of the centralized processing processes plus one.

In view of the implementation of data exchange between the radar unit and an external circuit at any of the foregoing data processing stages, an embodiment will be described below as an example.

An embodiment of the present disclosure provides a radar system including a plurality of radar units, each of the radar units including: at least one radio frequency channel, wherein each radio frequency channel is configured to obtain a received signal and generate an analog input signal from the received signal; a processing module connected to the at least one radio frequency channel; wherein the processing module is configured to sample the analog input signal to obtain a digital signal, and perform a first digital signal processing process on the digital signal to obtain intermediate data; wherein when the plurality of radar units work jointly, data exchange is performed among the plurality of radar units to equally divide all the intermediate data, and after the data exchange, all data units having a same index value in the intermediate data are concentrated into a radar unit corresponding to the index value; and the plurality of radar units perform second digital signal processing based on the intermediate data after the data exchange so that load balancing is achieved when the plurality of radar units perform the second digital signal processing.

The radar system of the present embodiment includes a plurality of radar units, one of which is illustrated in FIG. 10A. However, the plurality of radar units in this embodiment are not limited to being cascaded, and may be connected by bus or other connection methods. The radar system of the present embodiment may be a distributed radar system, a vehicle-mounted radar system of a satellite architecture, or the like.

The radar system of that present embodiment perform a processing step, such as at least one of first-dimensional Fourier transform (1D-FFT), second-dimensional Fourier transform (2D-FFT), Constant False Alarm Rate (CFAR: Constant False Alarm Rate) detection, direction of arrival (DoA) estimation, target tracking, point cloud imaging, etc., the plurality of radar units obtain respective intermediate data; the intermediate data may be divided into a plurality of data units from one or more dimensions, which may be distance, Doppler, angle, target, etc. Data units in the intermediate data may be distinguished by index values (index). In some alternative examples, when the signal processing includes Fourier transform processing, when the radar system performs the Fourier transform processing on a signal, the data units in the intermediate data may be equally divided into N parts among the N radar units based on index values of the range dimension and/or the Doppler dimension respectively, wherein the N parts are corresponding to the N radar units, N≥2. Uniformity here does not require absolute equality. For example, when the number of the data units cannot be evenly divided by N, some parts can have one more data unit.

Taking the range dimension as an example, an index value of a range gate can be used to distinguish data on each range gate (referred to as a range gate data unit). Assuming that the number of the radar units is 2 and 256 range gates are included in the range dimension, 128 range gate data units with odd index values may correspond to one radar unit and 128 range gate data units with even index values may correspond to another radar unit. After the data units in the intermediate data are equally divided into N parts, the numbers of data units in the parts are equal or have a difference of 1 therebetween. A plurality of radar units perform data exchange based on the index values of the data units, all data units having a same index value in the intermediate data may be concentrated into a radar unit corresponding to the index value.

In the radar system according to the embodiment of the present disclosure, when a plurality of radar units work jointly, the radar units may perform data exchange on the intermediate data obtained in the first digital signal processing process based on the index values of the data units and the number of radar units to equally divide all the intermediate data, so that data amounts of the intermediate data processed by the plurality of radar units when performing the second digital signal processing are the same or basically the same, thereby achieving load balancing. Through the load balancing, loads of a plurality of radar units in operation can be balanced, thus data processing resources in the radar system can be utilized to the greatest extent, and the processing capacity requirement on a single radar unit is low, which makes the radar system have better scalability and a reduced cost, so that the number of radio frequency channels can be easily increased to build a large-scale radar system. After the data exchange, all data units having the same index value in the intermediate data are concentrated into a radar unit corresponding to the index value, so that the second digital signal processing and subsequent processing can be performed based on the received data of all antennas, and the processing performance of the radar system is improved, such as improved detection accuracy.

In an exemplary embodiment of the present disclosure, when a radar unit corresponds to a plurality of channels, the data exchange may be performed after channel merging of respective intermediate data.

In an exemplary embodiment of the present disclosure, the intermediate data is a 1D-FFT result, a 2D-FFT result, or an object detection result.

In one example, the intermediate data is a 1D-FFT result and after the plurality of radar chips respectively perform processing such as ADC and Sampling on the echo signal, the range dimension (rang) FFT (i.e., 1D-FFT) is continuously performed to obtain 1D-FFT data (i.e., the 1D-FFT result) as the intermediate data. At this time, the 1D-FFT data of the plurality of radar chips may be equally divided based on index values (index) of the range gates, and the 1D-FFT data may be exchanged among the plurality of radar chips; subsequently, the plurality of radar chips perform subsequent doppler FFT (2D-FFT), target detection, and other processing based on the 1D-FFT data concentrated in the current radar chip after exchange. When the plurality of radar chips perform subsequent processing such as 2D-FFT, the data amounts to be processed by the plurality of radar units are relatively balanced.

In another example, the intermediate data is a 2D-FFT result, and the plurality of radar chips respectively perform, for example, ADC, sampling, range-dimensional FFT, and Doppler-dimensional FFT (i.e., 2D-FFT) on the echo signal to obtain 2D-FFT data (i.e., the 2D-FFT result) as the intermediate data. At this time, the 2D-FFT data of the plurality of radar chips may be equally divided based on the index values of the Doppler dimensional data units, and the 2D-FFT data may be exchanged among the plurality of radar chips; subsequently, the plurality of radar chips then perform subsequent target detection processing (such as CFAR) based on the 2D-FFT data concentrated into the current radar chip after exchange. When the plurality of radar chips perform subsequent processing such as target detection, data amounts to be processed by the plurality of radar units are relatively balanced.

In another example, the intermediate data is a target detection result, the plurality of radar chips respectively perform, for example, ADC, sampling, range-dimensional FFT, Doppler-dimensional FFT, and target detection, on the echo signal, and detected target data (i.e., the target detection result) is used as the intermediate data. At this time, the target data detected by the plurality of radar chips may be equally divided based on index values of data units in dimensions such as distance, speed, angle (such as pitch angle and/or azimuth angle), target, etc., and the target data may be exchanged among the plurality of radar chips; subsequently, the plurality of radar chips then perform subsequent processing such as target tracking based on the target data concentrated in the current radar chip after exchange. When the plurality of radar chips perform subsequent processing, data amounts to be processed by the plurality of radar units are relatively balanced.

In an exemplary embodiment of the present disclosure, the radar system includes two radar units, and through data exchange between the two radar units, all data units having odd index values in the intermediate data are concentrated into one radar unit, and all data units with even index values in the intermediate data are concentrated into another radar unit.

In actual operation, for a radar system including two cascaded radar units, data exchange may be performed between the two radar units according to parity of index values of range gates after the range dimension FFT, and data units of range gate with odd index values are concentrated into a first radar unit through the data exchange, and data units of range gates with even index values are concentrated into a second radar unit, that is, the first radar unit retains data units of range gate with odd index values in its own 1D-FFT data and acquires data units of range gates with odd index values on the second radar unit; and the second radar unit retains data units of range gates with even index values in its own 1D-FFT data, and acquires data units of range gates with even index values on the first radar unit, so that each radar unit only needs to process half the data amount in the subsequent Doppler dimension FFT processing, thereby achieving load balancing.

Although the present embodiment takes two radar units as an example, the present disclosure may be extended to a radar system including three or more radar units. In another embodiment in which three radar units are cascaded, data units may be allocated to the radar units based on multiples of 3. All the data units in the intermediate data obtained by the three radar units may be evenly divided into three parts based on index values. By analogy, for N (N≥2) radar units which are cascaded or connected in another manner, all data units in the intermediate data may be evenly divided into N parts based on index values, and each data unit may be concentrated into a corresponding radar unit through data exchange, so that the radar units can balance their loads in subsequent processing operations and maximize utilization of data processing resources in the radar system.

Taking a three-chip cascade radar system as an example, as shown in FIG. 10B, the radar system includes one master chip 2100A and two slave chips 2100B. It is assumed that the number of range gates of each of the master chip and the two slave chips is 128, and their index values are 0-127. In this embodiment, data units of range gates having index values of 0, 3, 6, . . . , 126 are concentrated into the master chip, data units range gates having index values of 1, 4, 7, . . . , 127 are concentrated into a first slave chip, and data units range gates having index values of 2, 5, 8, . . . , 125 are concentrated into a second slave chip through data exchange. When 128 can not be evenly divided by 3, the number of data units of range gates concentrated to each of the master chip and the first slave chip is 43, and the number of data units of range gates concentrated to the second slave chip is 42.

In actual processing, the master chip retains the data units of the range gates with index values of 0, 3, 6, . . . , 126 obtained by the processing of the master chip, transmits the data units of the range gates with index values of 1, 4, 7, . . . , 127 to the first slave chip, and transmits the data units of the range gates with index values of 2, 5, 8, . . . , 125 to the second slave chip. The first slave chip retains the data units of the range gates with index values of 1, 4, 7, . . . , 127 obtained by the processing of the first chip, transmits the data units of the range gates with index values of 0, 3, 6, . . . , 126 to the master chip, and transmits the data units of the range gates with index values of 2, 5, 8, . . . , 125 to the second slave chip. The processing of the second slave chip Slave 2 is similar and will not be described in detail. The data exchange may be performed by a processing module of each chip, or a data control unit may be provided, for example, on the master chip, and the data control unit implements the data exchange between different processing chips.

In an exemplary embodiment of the present disclosure, all index values of the data units are divided into M×N groups. Each group has K consecutive index values, each radar unit corresponds to M groups of index values distributed at equal intervals with the interval being N−1 group(s) of index values, and index values corresponding to different radar units are different; wherein N is the number of the plurality of radar units, M, N≥2, K≥1.

Among the M×N groups of index values obtained by equally dividing all the index values, index values corresponding to N radar units are distributed in a staggered manner. In the foregoing embodiment, such staggered manner is that N consecutive index values correspond to N radar units sequentially, for example, odd index values correspond to master radar units and even index values correspond to slave radar units, which is equivalent to a case where K=1, but the present disclosure is not limited thereto.

In another embodiment, consecutive N groups of index values correspond sequentially to N radar units, with each group having K index values, K≥2. Still assuming that the radar system includes one master radar unit and one slave radar unit, the number of radar units N=2, and taking the number of range gates being 128, K=2 as an example, since M×N×K=128, it can be calculated that M=32, that is, each radar unit corresponds to 32 groups of index values. In another embodiment, when the index values 0 to 127 of the range gate are divided into M×N=64 groups, the index values of the 64 groups are {0, 1}, {2, 3}, {4, 5}, {6, 7}, {8, 9}, {10, 11}, . . . , {124, 125}, {126, 127} in sequence. According to the correspondence method between index values and radar units in the present embodiment, M=32 groups of index values corresponding to each radar are distributed at equal intervals with the interval being N−1=1 group, and when {0, 1}, which is the first group of index values, can be corresponding to the master radar unit, the 32 groups of index values corresponding to the master radar unit are {0, 1}, {4, 5}, {8, 9}, . . . , {124, 125}, and the 32 groups of index values corresponding to the slave radar unit are {2,3}, {6,7}, {10,11}, . . . , {126,127} respectively, and different radar units correspond to different index values. When the N value, the K value, and the number of range gates are a combination of other numerical values, index values corresponding to each radar unit can also be determined according to the correspondence rule between the radar units and the index values of the present embodiment, so that data units having a same index value can be grouped into a radar unit corresponding to the index value through data interaction.

In the present embodiment, the number K of each group of index values may be taken according to calculation efficiency, transmission efficiency, limit on the number of index values of an interval, and the like, for example, in an example of the present embodiment, K=1, 2, 3, 4, 5, 6, 7, or 8.

In the present embodiment, each radar unit corresponds to M groups of index values distributed at equal intervals, and index values corresponding to a plurality of radar units are distributed in a cyclic staggered manner. Compared with a solution in which two distance ranges are divided according to distances, and range gate data units of the two distance ranges are respectively concentrated into two chips through data exchange, after the data exchange in the present embodiment, probabilities of target points appearing in the range gate data units processed by a plurality of radar units are more balanced. Because the previous solution is equivalent to dividing a space into two parts, when there are more and fewer targets in these two parts, radar units corresponding to a distance range containing more targets will detect more potential target points, resulting in that a plurality of radar units have unbalanced subsequent processing capacity of potential target points. In this embodiment, the index values of the range gates corresponding to the plurality of radar units are cyclically alternated, which is equivalent to dividing a graph into a plurality of thin strips, and transferring the thin strips to different radar units for processing them in a cyclically alternating manner. As long as a target crosses range gates, the plurality of radar units can all detect potential target points of the target. Therefore, regardless of whether the target is evenly distributed throughout the entire distance range, the potential target points subsequently detected by the plurality of radar units will be more balanced. The present embodiment can avoid imbalance of amount of subsequent calculation caused by imbalance of a target within a detection range, and the load is more balanced than that in the previous solution.

In an example of the present embodiment, the radar system includes two radar units, and all data units corresponding to index values of odd-numbered groups in the intermediate data are concentrated into one radar unit, and all data units corresponding to index values of even-numbered groups in the intermediate data are concentrated into another radar unit through data exchange between the two radar units.

Assuming that M×N is an even number, the M×N groups obtained by equally dividing all index values are the first group, the second group, the third group, the fourth group, . . . , the M×N−1 group, and the M×N−1 group, wherein the first group, the third group, . . . , and the M×N−1 group are odd-numbered groups, and the second group, the fourth group, . . . , and the M×N-th group are even-numbered groups. Still taking the example in which 64 groups of index values are {0, 1}, {2, 3}, {4, 5}, {6, 7}, {8, 9}, {10, 11}, . . . , {124, 125}, {126, 127} as an example, all data units corresponding to index values of odd-numbered groups in intermediate data are concentrated into one radar unit, that is, 32 groups of index values {0, 1}, {4, 5}, {8, 9}, . . . , {124, 125} are concentrated into one radar unit. All data units corresponding to index values of even-numbered groups in the intermediate data are concentrated into another radar unit, that is, 32 groups of index values {2, 3}, {6, 7}, {10, 11}, . . . , {126, 127} are concentrated into another radar unit.

If the number N of the radar units is 3, after all index values are divided into M×N groups, the first radar unit corresponds to the first group, the fourth group, the seventh group, . . . ; the second radar unit corresponds to the second group, the fifth group, the eighth group, . . . ; the third radar unit corresponds to the third group, the sixth group, the ninth group . . . . M groups of index values corresponding to each radar unit are distributed at equal intervals, with the interval being N−1=2 groups of index values, and the number of groups in this interval is not included in the groups corresponding to the radar unit.

In an exemplary embodiment of the present disclosure, the second digital signal processing performed by the plurality of radar units based on the intermediate data after data exchange includes two-dimensional fast Fourier transform (2D-FFT) and target detection, and target point data obtained by the second digital signal processing is aggregated to a designated radar unit for peak aggregation and angle detection.

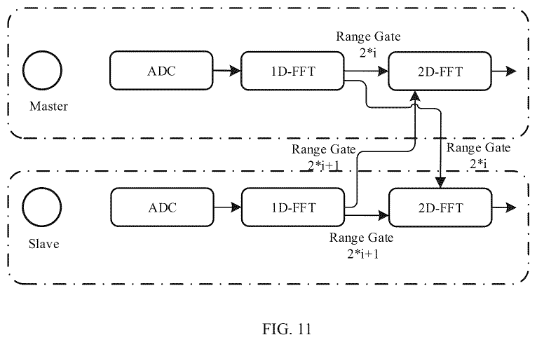

An embodiment of the present disclosure provides a radar system, which includes a master chip (Master) and a slave chip (Slave), adopts a dual-chip cascade scheme, and maintains a computing power balance between the two chips through data exchange between the two chips. As shown in FIG. 11, the signal processing flow is as follows: a received signal is subjected to ADC processing to sample the analog echo signal and filter out an interference signal, followed by performing a one-dimensional fast Fourier transform (1D-FFT), i.e. a preprocessing process; the master chip (Master) and the slave chip (Slave) exchange data through inter-chip interconnection (C2C): among all data units of range gates of the two chips, data units of range gates with even index values (represented as Range Gate 2*i in the figure) are concentrated on the master chip, and data units of range gates with odd index values (represented as Range Gate 2*i+1 in the figure) are concentrated on the slave chip, i=0, 1, 2, . . . . After the data exchange, the master chip performs two-dimensional fast Fourier transform (2D-FFT) on the data units of the range gates with the even index values, and the slave chip performs 2D-FFT on the data units of the range gates with the odd index values, and data amounts processed by the two chips are the same. After the 2D-FFT, the master chip and the slave chip perform target detection respectively, which may include: after obtaining potential target points through CFAR detection, are screening out final target points by one or more types of processing such as interpolation (improving target position accuracy), multi-feature screening (eliminating abnormal points based on amplitude, Doppler, etc.), clustering and morphological filtering (merging adjacent points and removing isolated false alarms), non-maximum value suppression (retaining local maximum values and suppressing redundant points). Target point data obtained by the master chip and the slave chip is then aggregated into one of the chips for processing such as angle detection and point cloud imaging. When the target point data is aggregated into one chip, transmission amount is small, and the angle detection after the aggregation is based on data received by all antennas of the two chips, which can achieve higher angular resolution.

When the master chip and the slave chip perform data exchange, if data units of range gates with index values {0, 2, 4, . . . , 254} on the slave chip are to be exchanged to the master chip, a processor of the master chip may read the data units of the range gates from the slave chip, or a processor of the slave chip may send the data units of the range gates to the master chip, or a data control unit (which may be provided on the master chip or the slave chip) transfers these data units of the range gates from the slave chip to the master chip, and the present disclosure is not limited thereto. The case is similar when data unit of range gates with index values {1, 3, 5, . . . , 255} on the master chip is exchanged to the slave chip.

In the present embodiment, in the 1D-FFT and the pre-processing before it, the processing of the master chip and the slave chip is the same. After the preprocessing, the data units of the range gates are exchanged between the master chip and the slave chip based on parity of the index values, all data units of range gates with odd index values are concentrated into the slave chip, and all data units of range gates with even index values are concentrated into the master chip, that is, the two chips re-unify all the data units of the range gates, and then the master chip and the slave chip each perform 2D-FFT operation on half of the data to achieve load balancing. Furthermore, compared with the scheme in which two distance ranges are divided according to distances and data units of range gates in the two distance ranges are respectively concentrated into two chips through data exchange, the data units of the range gates processed by the two chips in this embodiment are divided by parity of the index values, so that the potential target points detected by the CFAR are basically balanced on the two chips regardless of whether target distribution is balanced in the entire distance range, so that calculation amounts when processing the potential target points are also basically balanced. Therefore, the present embodiment can avoid imbalance of amount of subsequent calculation caused by imbalance of a target within the two distance ranges.

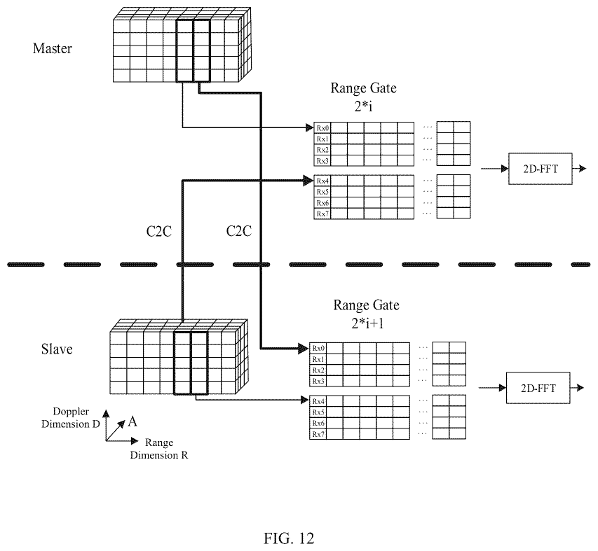

A data exchange process of the present embodiment will be described in detail with an example below. Referring to FIGS. 11 and 12, the master chip and the slave chip obtain their respective intermediate data after completing ADC and one-dimensional fast Fourier transform (1D-FFT). It is assumed that the master chip has 4 receive channels Rx0, Rx1, Rx2, Rx3, and the slave chip also has 4 receive channels Rx4, Rx5, Rx6, Rx7. The intermediate data obtained by each chip after the 1D-FFT processing is 4 channels of 1D-FFT data. In this example, each channel including data of 256 range gates is taken as an example. Each range gate may have multiple data, such as 512 complex data. The data of each range gate forms a data unit, which is called a range gate data unit, and an index of the range gate is an index of the range gate data unit.

In the example shown in FIG. 12, when data is exchanged between two chips, a processing module of the master chip (such as a sub-processing unit responsible for 2D-FFT processing) obtains data units of range gates with index values of {0, 2, 4, . . . , 254} of four receiving channels Rx4, Rx5, Rx6, and Rx7 from the slave chip through inter-chip interconnection (C2C) interface, and retains data units of range gates with index values of {0, 2, 4, . . . , 254} of four channels Rx0, Rx1, Rx2, and Rx3 of the master chip. At the same time, a processing module of the slave chip obtains data unit of range gates with index values {1, 3, 5, . . . , 255} of four receiving channels Rx0, Rx1, Rx2, and Rx3 from the master chip through the C2C interface, and retains data units of range gates with index values of {1, 3, 5, . . . , 255} of the four channels Rx4, Rx5, Rx6, and Rx7 of the slave chip. After the exchange, all the data units of the range gates with the same index value in the intermediate data are concentrated into the same chip and the data is equally divided. The master chip obtains all the data units of the range gates with even index values (represented as Range Gate 2*i in the figure), and the slave chip obtains all the data units of the range gates with odd index values (represented as Range Gate 2*i+1 in the figure), where i=0, 1, 2, . . . .

As shown in FIG. 12, after the two chips perform the data exchange, the two-dimensional fast Fourier transform (2D-FFT) operation of each range gate is performed independently by the two chips. Before performing 2D-FFT operations, the two chips may be windowed in their respective Doppler dimensions (Hanning windows are used by default). After the 2D-FFT processing is completed, 2D-FFT data may be sent to a CFAR engine for processing. Before the 2D-FFT data is sent to the CFAR engine, some processing may also be performed based on the 2D-FFT data, such as transmitting to histogram (HIST) engine to calculate noise of the current range gate.

In this embodiment, all index values of the range gate data units are divided into N×M groups, each group has one consecutive index value, and each chip corresponds to M groups of index values distributed at equal intervals, with the interval being N−1 groups of index values. N is the number of chips participating in data exchange, in this embodiment, N=2, the number of the range gates is 256, and M=128.

However, in another embodiment, it is not necessarily necessary to perform the data exchange according to the parity of the index values, and each group may have 2, 3, 4, 5, 6, 7, 8 or more consecutive index values. Still taking the two-chip radar system as an example, that is, N is equal to 2. When the number of range gates is 256, taking each group of 2 index values as an example, M=64, that is, each chip corresponds to 64 groups of index values distributed at equal intervals, and the interval is 1 group of 2 index values. When data exchange is performed between two chips, all data units of range gates having index values {0, 1, 4, 5, 8, 9, . . . , 252, 253} in the intermediate data are concentrated on the master chip, and all data units of range gates having index values {2, 3, 6, 7, 10, 11, . . . , 254, 255} are concentrated on the slave chip. After the data exchange, the number of range gate data units obtained by each chip is equal, and the index values of the range gate data units obtained by the two chips are distributed in groups in a staggered manner. In this manner, all intermediate data can be equally divided between the two chips, and compared with the scheme of dividing two distance ranges and one chip processing data in one distance range, in this embodiment, the probabilities of detecting target candidate points on respective range gates by the two chips are more equal in subsequent processing, and amounts of calculation when subsequently processing these candidate points are more balanced.

It should be noted that in this specification, the terms “comprise”, “comprising” and the like are used to refer to comprise in nonexclusive sense, so that any process, approach, article or apparatus relevant to an element, if follows the terms, means that not only the element listed here, but also those elements not listed explicitly, or those elements inherently included by the process, approach, article or apparatus relevant to the element. If there is no explicit limitation, the wording “comprise a/an . . . ” does not exclude the fact that other elements can also be included together with the process, approach, article or apparatus relevant to the element.

In accordance with the example embodiment of the present disclosure described above, the description of embodiments of the present disclosure are not intended to be exhaustive or limited to embodiments of the invention in the form disclosed. Obviously, according to the above description, there may be many modifications and variations. The embodiments in the present disclosure was chosen and described in order to explain the principles of the invention and as a practical application to enable persons skilled in the art to well utilize the invention in various embodiments and with various modifications. Accordingly, the protection scope of the present disclosure should be defined by attached claims.

What is claimed is:

1. A radar system, comprising a plurality of radar units, wherein each of the radar units comprises:
one or more radio frequency (RF) channels, wherein each of the one or more RF channels is configured to receive a signal and generate an analog input signal according to the received signal; and
a processing module coupled to the one or more RF channels, wherein the processing module is configured to sample the analog input signal to obtain a digital signal and perform a first digital signal processing to the digital signal, thereby obtaining intermediate data,
wherein when the plurality of radar units work jointly, a designated radar unit performs a second digital signal processing on a plurality of intermediate data provided by the plurality of radar units, thereby obtaining result data of the radar system, and
wherein when each of the radar units works alone, the processing module in the respective radar unit performs the second digital signal processing to the respective intermediate data, thereby obtaining the result data of the respective radar unit.

2. The radar system of claim 1, wherein in each of the radar units, the one or more RF channels comprises:
one or more receiving antennas configured to obtain the signal; and
a front-end module coupled to the one or more receiving antennas and configured to convert the signal to the analog input signal according to a local oscillator (LO) signal;
and wherein the processing module comprising:
an analog-to-digital converter (ADC), configured to obtain the digital signal by sampling the analog input signal according to a sampling clock signal; and
a radar processor including 1st to Mth sub-processing units and storage units, the storage units being configured to store at least one of the intermediate data and the result data, the 1st to Kth sub-processing units being used for implementing the first data processing, the K+1th to Mth sub-processing units being used for implementing the second data processing, wherein M is a natural number greater than or equal to 2 and K is a natural number greater than or equal to 1 and less than M.

3. The radar system of claim 2, wherein the 1st to Mth sub-processing units respectively perform at least part of processes of the following data processing: Fourier transform, target detection, angle detection, and point cloud imaging.

4. The radar system of claim 2, wherein the first data processing includes a first-dimensional fast Fourier transform (1D-FFT), a second-dimensional fast Fourier transform (2D-FFT), and target detection.

5. The radar system of claim 1, wherein:
the plurality of radar units comprise a master radar unit and a plurality of slave radar units, and
when the plurality of radar units work jointly, the master radar unit generates and transmits the LO signal and the sampling clock signal to the plurality of slave radar units.

6. The radar system of claim 1, wherein the intermediate data comprises FFT result data or is obtained based on FFT result data, the FFT result data being obtained by performing FFT on the digital signal of the radar unit, and
wherein when the plurality of radar units work jointly, a designated radar unit among the plurality of radar units performs the second digital signal processing to the intermediate data provided by all the plurality of radar units, thereby obtaining the result data of the radar system.

7. The radar system of claim 6, wherein:
the intermediate data comprises any one or more of 1D-FFT result data, 2D-FFT result data, target detection result data, and angle detection result data, and
the result data of the radar system comprises at least one of angle detection result data and point cloud imaging result data.

8. The radar system of claim 6, wherein:
the first digital signal processing comprises 1D-FFT, or comprises 1D-FFT and 2D-FFT, or comprises 1D-FFT, 2D-FFT and target detection, or comprises 1D-FFT, 2D-FFT, target detection, and angle detection, and
the second digital signal processing comprises at least one of angle detection and point cloud imaging.

9. The radar system of claim 1, wherein the plurality of radar units comprises at least two cascaded radar units, and
wherein the result data is at least one of angle detection data and point cloud imaging data.

10. The radar system of claim 9, wherein:
in a link composed of the at least two cascaded radar units, a radar unit cascaded at a first stage directly transmits calculated result data of the radar unit to a radar unit of a second stage,
the radar unit of the second stage combines calculated result data of the radar unit of the second stage and the received result data of the radar unit of the first stage, obtains a modulus, and transmits the modulus to a radar unit of a next stage, and so on, and finally the result data is obtained at the radar unit of the last stage, and
the result data is an energy distribution spectrum.

11. A radar system comprising a plurality of cascaded radar units, wherein the plurality of radar units comprises a master radar unit and at least one slave radar unit, the master radar unit is configured to provide a local oscillator signal and a sampling clock signal to the master radar unit and all of the at least one slave radar unit so that local oscillator signals and sampling clock signals of the all radar units in the radar system are synchronized.

12. The radar system of claim 11, wherein each of the radar units comprises:
at least one radio frequency channel, wherein each radio frequency channel is configured to obtain a received signal and generate an analog input signal according to the received signal; and
a processing module coupled to the at least one radio frequency channel, wherein the processing module is configured to sample the analog input signal to obtain a digital signal, and perform a first digital signal processing to the digital signal, thereby obtaining intermediate data,
wherein when each of the radar units works alone, the processing module in the respective radar unit performs a second digital signal processing to the respective intermediate data, thereby obtaining the result data of the respective radar unit,
wherein when the plurality of radar units work jointly, a designated radar unit performs the second digital signal processing to a plurality of intermediate data provided by the plurality of radar units, thereby obtaining result data of the radar system; or when the plurality of radar units work jointly, data exchange is performed among the plurality of radar units to equally divide all the intermediate data of the plurality of radar units, and all data units having a same index value in the intermediate data after the data exchange are concentrated into a radar unit corresponding to the index value; and the plurality of radar units perform the second digital signal processing based on the intermediate data after the data exchange so that load balancing is achieved when the plurality of radar units perform the second digital signal processing.

13. The radar system of claim 11, wherein:
the radar system is configured to perform data processing to an echo signal to obtain the result data,
the data processing comprises a distributed processing and a subsequent centralized processing,
the distributed processing is respectively executed in each radar unit,
the centralized processing is executed in the master radar unit, and
when each radar unit performs the distributed processing, the each radar unit respectively performs the distributed processing based on the echo signal received by the radar unit itself.

14. The radar system of claim 13, wherein the data processing further comprises at least one subsequent distributed processing, or the data processing further comprises at least one subsequent distributed processing and at least one subsequent centralized processing, and
wherein the distributed processing and the centralized processing are executed alternately, and the number of times of the distributed processing is equal to the number of times of the centralized processing, or the number of times of the distributed processing is equal to the number of times of the centralized processing plus one.

15. A radar system comprising a plurality of radar units, each of the radar units comprising:
at least one radio frequency channel, wherein each radio frequency channel is configured to obtain a received signal and generate an analog input signal according to the received signal; and
a processing module coupled to the at least one radio frequency channel, wherein the processing module is configured to sample the analog input signal to obtain a digital signal, and perform a first digital signal processing to the digital signal, thereby obtaining intermediate data,
wherein when the plurality of radar units work jointly, data exchange is performed among the plurality of radar units to equally divide all the intermediate data of the plurality of radar units, and after the data exchange, all data units having a same index value in the intermediate data are concentrated into a radar unit corresponding to the index value, and
wherein the plurality of radar units perform a second digital signal processing based on the intermediate data after the data exchange so that load balancing is achieved when the plurality of radar units perform the second digital signal processing.

16. The radar system of claim 15, wherein the plurality of radar units perform channel merging processing to respective intermediate data before performing the data exchange.

17. The radar system of claim 15, wherein the intermediate data is a 1D-FFT result, a 2D-FFT transform result, or a target detection result.

18. The radar system of claim 15, wherein:
all index values of the data units are divided into M×N groups, N being the number of the plurality of radar units,
each group has K consecutive index values,
each radar unit corresponds to M groups of index values distributed at equal interval with the interval being N−1 groups of index values,
index values corresponding to different radar units are different, and
M≥2, N≥2, K≥1.

19. The radar system of claim 18, wherein:
the radar system comprises two radar units,
all data units corresponding to index values of odd-numbered groups in the intermediate data are concentrated into one radar unit, and
all data units corresponding to index values of even-numbered groups in the intermediate data are concentrated into the other radar unit through data exchange between the two radar units.

20. The radar system of claim 15, wherein:
the radar system comprises two radar units,
all data units with odd index values in the intermediate data are concentrated to one radar unit, and
all data units with even index values in the intermediate data are concentrated to the other radar unit through data exchange between the two radar units.

21. The radar system of claim 15, wherein:
the second digital signal processing performed by the plurality of radar units based on the intermediate data after the data exchange comprises two-dimensional fast Fourier transform and target detection, and
target point data obtained by the second digital signal processing is then aggregated to a designated one of the radar units for peak aggregation and angle detection.
